(19) United States
(12) Patent Application Publication
(10) Pub. No.: US 2007/0101279 A1
(43) Pub. Date: May 3, 2007

(54) Selection of user interface elements for unified display in a display environment

(76) Inventors: Imran A. Chaudhri, San Francisco, CA (US); Scott Forstall, Mountain View, CA (US); John O. Louch, San Luis Obispo, CA (US); Eric Steven Peyton, Lisle, IL (US)

Correspondence Address: FISH & RICHARDSON P.C., PO BOX 1022, MINNEAPOLIS, MN, 55440-1022, US

(21) Appl. No.: 11/357,730

(22) Filed: Feb. 16, 2006

Related U.S. Application Data
(60) Provisional application No. 60/730,956, filed on Oct. 27, 2005.
(60) Provisional application No. 60/734,016, filed on Nov. 4, 2005.
(60) Provisional application No. 60/737,899, filed on Nov. 18, 2005.

(51) Int. Cl. G06F 9/00; G06F 3/00

(52) U.S. Cl. 715/762; 715/764; 715/765; 715/810

(57) ABSTRACT

Methods, systems, apparatus and computer program products are provided. One method is provided that includes determining for a display environment when a number of unspecified user interface elements are desired to be displayed, automatically selecting user interface elements from available user interface elements to satisfy the number and displaying the selected user interface elements in the display environment.

### RELATED APPLICATIONS

This application is generally related to the following jointly owed and co-pending patent applications, each incorporated herein by reference in its entirety:
U.S. Provisional Patent Application No. 60/583,125, for “Procedurally Expressing Graphic Objects for Web Pages,” filed Jun. 25, 2004;
U.S. patent application Ser. No. 10/874,829, for “User Interface for Assisting in the Installation of an Asset,” filed Jun. 22, 2004;
U.S. patent application Ser. No. 11/145,561, for “Presenting Clips of Content,” filed Jun. 3, 2005;
U.S. patent application Ser. No. 11/145,560, for “Web View Applications,” filed Jun. 3, 2005;
U.S. patent application Ser. No. 11/145,023, for “Clip View Applications,” filed Jun. 3, 2005;
U.S. patent application Ser. No. 11/148,010, for “Preview and Installation of User Interface Elements in a Display Environment,” filed Jun. 7, 2005; and
U.S. Provisional Patent Application No. 60/730,956, filed Oct. 27, 2005, entitled “Widget Security,” Attorney Docket No. 18962-017P01.
U.S. Provisional Patent Application No. 60/734,016, filed Oct. 27, 2005, entitled “Preview Including Theme Based Installation of User Interface Elements in a Display Environment,” Attorney Docket No. 18962-015P01.
U.S. Provisional Patent Application No. 60/737,899, filed Nov. 18, 2005, entitled “Management Of User Interface Elements In A Display Environment,” Attorney docket No. 18962-018P01.
U.S. patent application Ser. No. 11/346,603 for “Multiple Dashboards,” filed Feb. 1, 2006.

### TECHNICAL FIELD

The disclosed implementations relate generally to graphical user interfaces.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

Although users appreciate interfaces that can present information on a screen via multiple windows, the result can be overwhelming. For example, users may find it difficult to navigate to a particular user interface element or to locate a desired element among a large number of onscreen elements. The problem is further compounded when user interfaces allow users to position elements in a desired arrangement, including overlapping, minimizing, maximizing, and the like. Although such flexibility may be useful to the user, it can result in a cluttered display screen. Having too many elements displayed on the screen can lead to “information overload,” thus inhibiting the user to efficiently use the computer equipment.

Many of the deficiencies of conventional user interfaces can be reduced using “widgets.” Generally, widgets are user interface elements that include information and one or more tools (e.g., applications) that let the user perform common tasks and provide fast access to information. Widgets can perform a variety of tasks, including without limitation, communicating with a remote server to provide information to the user (e.g., weather report), providing commonly needed functionality (e.g., a calculator), or acting as an information repository (e.g., a notebook). Widgets can be displayed and accessed through a user interface, such as a “dashboard.” Widgets and dashboards are described in co-pending U.S. patent application Ser. No. 10/877,968, entitled “Unified Interest Layer For User Interface.”

Due to the large number of widgets available to a user, a virtual desktop or dashboard can become cluttered and disorganized, making it difficult for the user to quickly locate and access a widget. Further, a user interacting with a device may not be aware of the widgets that are available and that would otherwise be of assistance to a user.

### SUMMARY

In one aspect, a method is provided that includes determining for a display environment when a number of unspecified user interface elements are desired to be displayed, automatically selecting user interface elements from available user interface elements to satisfy the number and displaying the selected user interface elements in the display environment.

Aspects of the invention can include one or more of the following features. Determining a number can include determining available space for presentation of unspecified user interface elements, receiving user input defining a number of unspecified user interface elements to automatically populate in the display environment, determining a number of user interface elements that can be displayed in the display environment such that all user interface elements that are to be displayed are automatically selected rather than explicitly defined. Automatically selecting can include identifying one or more criterion for making a selection, and selecting in accordance with the criterion. Automatically selecting can also include determining user preferences for selection, and using the user preferences in selecting the user interface elements for display. Automatically selecting can include determining a current context, and selecting user interface elements in accordance with the context. Displaying can include displaying the selected user interface elements in a predetermined portion of the display environment and displaying a designator along with the user interface element to indicate the selection was automatically made. The method can further include determining if an update to the display environment is required, and if so, then updating display including repeating one or more of the determining, selecting and displaying steps.

In another aspect a method for populating a dashboard is provided that includes determining a number of unspecified widgets that are desired to populate a dashboard, determining one or more criterion for selecting from available widgets, selecting from the available widgets in accordance with the criterion and displaying the selected widgets in the dashboard.

In another aspect a user interface method is provided that includes determining a number of unspecified user interface elements to be displayed in a user interface, an user interface unspecified element being one not explicitly specified by either a user or a system prior to generation of the user interface, selecting user interface elements from available user interface elements based on one or more criterion to satisfy the number and displaying the selected user interface elements along with any other explicitly specified user interface elements in the user interface.

In another aspect a method is provided that includes determining when a number of unspecified user interface elements are desired to be displayed in a display environment and automatically populating the display environment with selected user interface elements from available user interface elements in accordance with population parameters.

In another aspect a method is provided that includes identifying a user interface for display in a display environment and automatically populating the user interface with selected user interface elements in accordance with population parameters. Automatically populating includes determining a number of user interface elements that need to be specified and selecting the specified number of user interface elements from available user interface elements.

In another aspect a method is provided that includes determining if a display environment requires additional user interface elements beyond those specified by a user, an operating system or an active application. If so, the method includes selecting a number of user interface elements from available user interface elements in accordance with one or more criterion and displaying the selected user interface elements in the display environment along with any other explicitly specified user interface elements.

In one implementation, a dashboard (also referred to as a “unified interest layer”) is provided that includes user interface elements that are presented to the user, the user interface elements being determined, for example, dynamically based on the context of use. The population of the dashboard can be determined at the time of presentation, and can be updated at predetermined times. The dashboard can contain any number of user interface elements, referred to herein as “widgets,” for quick access by a user. In response to a command from a user, the dashboard can be invoked, a set of widgets determined from the available widgets and the widgets can be displayed in a display area. In some implementations, dynamically selected widgets can comprise a subset of all the widgets displayed in the display area.

Widgets can be of any type. They can communicate with a remote server to provide information to the user (e.g., a weather report), or they can provide commonly needed functionality (e.g., a calculator), or they can act as an information repository (e.g., a notepad or calendar). Some widgets can provide a combination of these types of functions.

Aspects of the invention can include one or more of the following features. The display environment can be a desktop, dashboard, or other portion of a user interface associated with a computing device, desktop computer, laptop computer, a game console or display, a communication device, a personal digital assistant, a portable electronic device, a television, monitor or other display device or the like. The automatic selection of widgets from available widgets can be based on the context of use of the underlying device. The number of widgets that are automatically selected can be selectable, variable, or otherwise configurable. The automatic selection of widgets can be made from widgets that are available locally on the device, or at other locations that are accessible by the device.

### BRIEF DESCRIPTION OF THE DRAWINGS

FIG. 1 is a block diagram of a hardware architecture for automatically populating widgets in a display environment.

FIG. 2 is a flow diagram of a process for activating and using a dashboard.

FIG. 3 is a block diagram depicting a software architecture for automatically populating widgets in a display environment.

FIG. 4a is an exemplary screen shot depicting a desktop user interface prior to activation of a dashboard.

FIG. 4b is an exemplary screen shot depicting an initial state for a dashboard where no automatic selection is required.

FIG. 4c is an exemplary screen shot depicting an initial state of a dashboard when automatic selection is enabled, showing one automatically specified widget along with other explicitly specified widgets.

FIG. 4d is an exemplary screen shot depicting a management window for selecting preferences associated with the automatic population process.

FIG. 5 is a software architecture for a selection process.

FIG. 6 is a flow diagram of a method for automatically populating a dashboard.

### DETAILED DESCRIPTION

### Hardware Architecture

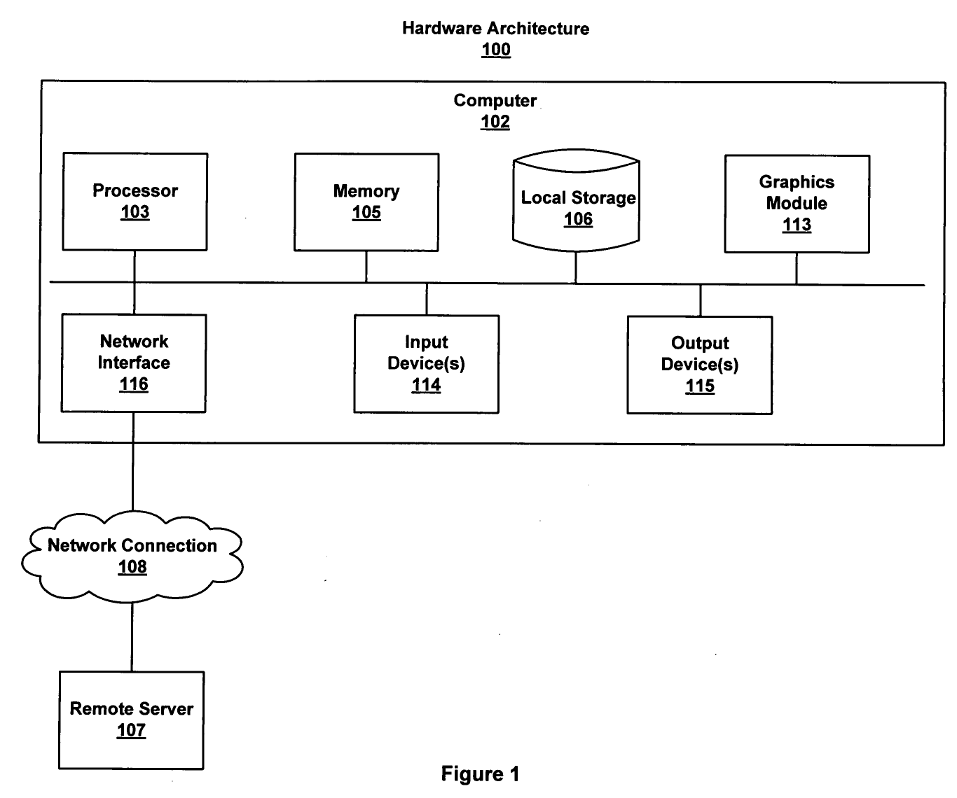

FIG. 1 is a block diagram of an exemplary hardware architecture 100 for automatically populating user interface elements (e.g. widgets) in a display environment. The display environment can be a dashboard, a desktop, or a user interface associated with a device. Reference is made here to hardware and software architectures for automatically populating widgets in a display environment. The methods and structures can be implemented in other configurations including hardware, software, firmware, or combinations of the same. Further, for the purposes of clarity, processes are described below in a specific application based environment. Other environments are possible including distributed environments, client-server environments, non-computing environments and the like.

Architecture 100 includes a personal computer 102 coupled to a remote server 107 via a network connection 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user 101 interacts with the architecture 100 via the input and output devices 114, 115.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While dashboards and widgets are described herein with respect to a personal computer 102, it should be apparent that the disclosed implementations can be incorporated in, or integrated with, any electronic device that is capable of using user interface elements (e.g. widgets), including without limitation, portable and desktop computers, servers, electronics, media players, game devices, mobile phones, email devices, personal digital assistants (PDAs), embedded devices, televisions, etc.

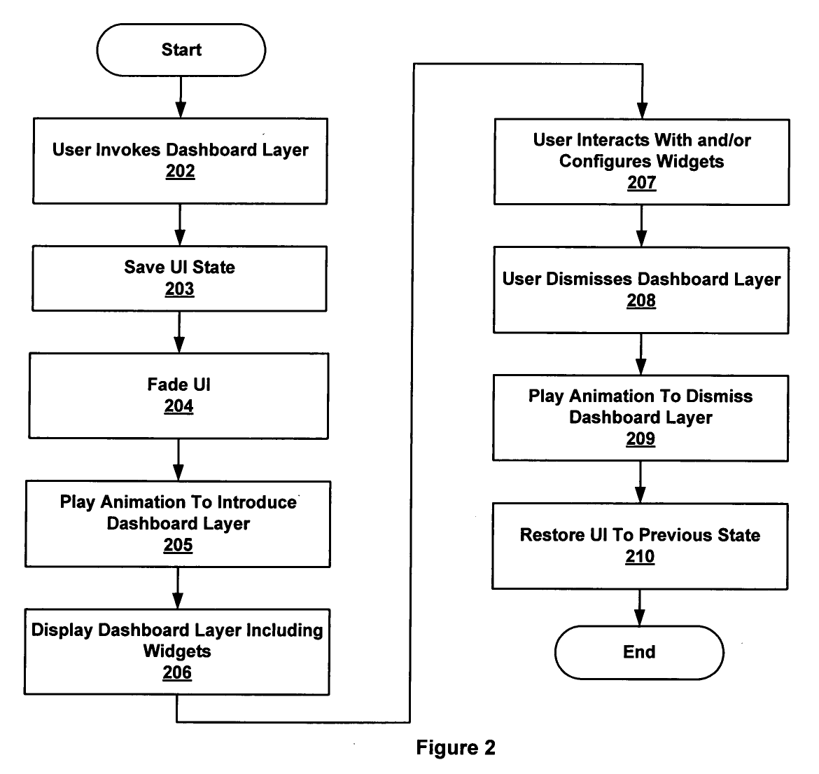

Systems and methods for automatically populating a display environment with user interface elements (e.g. widgets) can be implemented as one or more plug-ins that are installed and run on the personal computer 102. The plug-ins are configured to interact with an operating system (e.g., MAC OS® X, WINDOWS XP, LINUX, etc.) and to perform the various dashboard, UI and widget functions, as described with respect of FIGS. 2-6. The systems and methods can also be implemented as one or more software applications running on the computer 102 or embedded applications on a display device. Such systems and methods can also be characterized as a framework or model that can be implemented on various platforms and/or networks (e.g., client/server networks, stand-alone computers, portable electronic devices, mobile phones, etc.), and/or embedded or bundled with one or more software applications (e.g., email, media player, browser, etc.).

For illustrative purposes, in the following description the inventive methods and systems are described as features of an operating system for use in a dashboard environment; however, one skilled in the art will recognize that the techniques of the present invention can be implemented in other contexts as well, including those described above, to select and present other elements, and in other environments including environments associated with applications or operating systems. Examples of other environments include e-mail environments, desktop environments, application environments, hand-held display environments, and other display environments.

### Dashboard Overview

FIG. 2 is a flow diagram of an implementation of a process for activating and using a dashboard. A dashboard layer (also referred to herein as a “unified interest layer” or “dashboard”) can be used to manage and display user interface elements (e.g. widgets). A user can invoke a dashboard (202) by hitting a designated function key or key combination, or by clicking on an icon, or by selecting a command from an onscreen menu, or by moving an onscreen cursor to a designated corner of the screen. Alternatively, a dashboard can be invoked automatically in response to user interaction, or other triggers (at start up of an application, at occurrence of a predefined event, at expiration of a predetermined amount of time, etc.). The user interaction or trigger can be associated with an unrelated application or other process otherwise unrelated to the dashboard functions. For example, a dashboard manager can have associated default or otherwise designated trigger conditions specified as to when to launch a dashboard. In response to such user input or otherwise trigger, the current state of the user interface can, in one implementation, be saved (203), the user interface can be temporarily inactivated (204), an animation or effect can be played or presented to introduce the dashboard (205) and the dashboard can be displayed with one or more user interface elements (e.g. widgets) (206). If applicable, a previous state of the dashboard can be retrieved, so that the dashboard can be displayed in its previous configuration.

In some implementations, the dashboard is overlaid on an existing desktop user interface (UI). When the dashboard is activated, the existing UI may be faded, darkened, brightened, blurred, distorted, or otherwise altered to emphasize that it is temporarily inactivated. The existing desktop may or may not be visible behind the dashboard. The desktop can also be shrunk to a small portion of the display screen while the dashboard is active, and can be re-activated by clicking on it. In some implementations, the desktop is shrunk and presented as a widget. The desktop can be re-activated by clicking on the widget.

The user interacts with and/or configures user interface elements (e.g. widgets) as desired (207). In some implementations, the user can move widgets around the screen, and can resize widgets if applicable. As will be discussed below, one form of interaction relates to the configuration of population parameters associated with a given dashboard. Population parameters are discussed in greater detail below.

The user dismisses the dashboard (208) by invoking a dismissal command, which causes the normal UI to return or re-present itself to the display screen. In some implementations, the dashboard is dismissed when the user presses a function key or key combination (which may be the same or different than the key or combination used to activate the dashboard), or clicks on a close box or other icon, or clicks on negative space within the dashboard (e.g., a space between widgets), or moves an onscreen cursor to a predefined corner of the screen.

In some implementations, the dashboard is automatically dismissed (i.e., without user input) after some predetermined period of time or in response to a trigger event. An animation or other effect can be played or presented to provide a transition as the dashboard is dismissed (209). When the dashboard is dismissed, the current configuration or state of the user interface elements (e.g. widgets) (e.g., position, size, etc.) is stored as required, so that they can be retrieved the next time the dashboard is activated. In some implementations, an animation or effect can be played or presented when re-introducing the UI. The UI is restored to its previous state (210) so that the user can resume interaction with software applications and/or the computer operating system.

In some implementations, the dashboard is configurable. The user can select a number of user interface elements (e.g. widgets) to be displayed, for example, by dragging the widgets from a configuration bar (or other user interface element) onto the dashboard. The configuration bar can include different types of widgets, and can be categorized and/or hierarchically organized. In some implementations, in response to the user dragging a widget onto the configuration bar, the widget is downloaded from a server and automatically installed (if not previously installed). In some implementations, certain widgets must be purchased, so the user is requested to provide a credit card number or some other form of payment before the widget is installed on the user's machine. In some implementations, widgets are already installed on the user's machine, but are only made visible when they have been dragged from the configuration bar onto the dashboard. The configuration bar is merely an example of one type of UI element for configuring the dashboard. Other configuration mechanisms can be used, such as an icon tray or menu system.

Configuration of the dashboard can be automated. That is, the determination of how many user interface elements (e.g. widgets) and which ones (including details of how to display the particular selected widgets) to display in a given display environment at a given time can be automated. Automation can include the selection of user interface elements (e.g. widgets) for presentation. The selection can be based on preferences (e.g., manually specified, inferred, or predetermined, etc.), hereinafter referred to as population parameters. Population parameters and the population of a dashboard/desktop/user interface environment is discussed in greater detail below.

It should be apparent that there are many ways in which dashboards and user interface elements (e.g. widgets) can be displayed other than those implementations described herein. For example, widgets can be displayed on any user interface or user interface element, including but not limited to desktops, browser or application windows, menu systems, trays, multi-touch sensitive displays and other widgets.

### Software Architecture

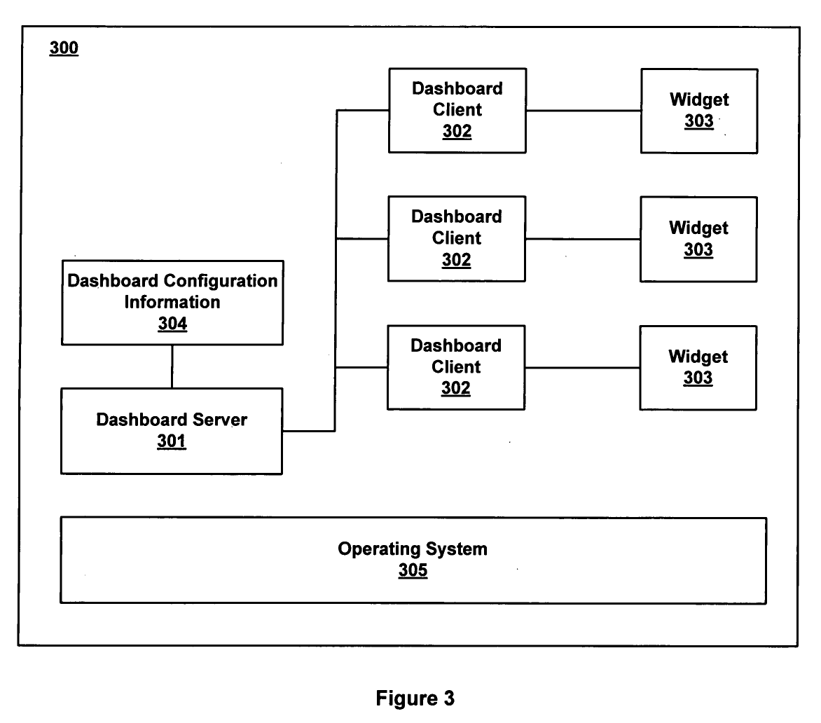

FIG. 3 is a block diagram of a software architecture 300 for automatically populating a display environment with user interface elements. The software architecture 300 generally includes a dashboard server 301, one or more dashboard clients 302, and one or more user interface elements (e.g. widgets 303). The server 301 and/or clients 302 use dashboard configuration information 304 to specify configuration options for displaying the widgets 303, including access levels and the like (if applicable). Such configuration information can include information for two or more dashboards configured by the same user or by different users.

In some implementations, the widgets 303 are displayed using HTML and related web technology. The dashboard server 301 manages and launches the dashboard client 302 processes. Each dashboard client 302 determines which widgets to load, and loads the selected widgets 303 (e.g., an HTML webpage) and related resources needed to display the page. In some implementations, the dashboard clients 302 display the widgets 303 without a conventional window frame, menu bar, or other components typically associated with on-screen windows. This technique provides a clean, straightforward display of the overall dashboard to reduce confusion and clutter. The dashboard clients 302 display their respective widgets 303 by rendering web pages into a “WebView,” as described in U.S. patent application Ser. No. 11/148,010, entitled “Preview and Installation of User Interface Elements in a Display Environment.” The size of each WebView is defined as metadata associated with the corresponding widget 303. The server 301 can provide data for rendering a separate layer that can be overlaid on the normal desktop of the user interface. The widgets 303 are rendered into the separate layer which is drawn on top of the normal desktop, so as to partially or completely obscure the desktop while the dashboard is active.

### Dashboard Server

The dashboard server 301 can be a stand-alone process or embedded in another process. The server 301 can be located at the computer 102 or at the remote server 107. In some implementations, the server 301 provides functionality for one or more processes, including but not limited to: non-widget UI management, window management, fast login, event management, loading widgets, widget arbitration, Core Image integration and widget preference management, as described herein and in U.S. patent application Ser. No. 11/148,010, entitled “Preview and Installation of User Interface Elements in a Display Environment.”

### Dashboard Client

In some implementations, a dashboard client 302 is a process that uses, for example, objects that are defined as part of a development environment, such as Apple Computer's Cocoa Application Framework (also referred to as the Application Kit, or AppKit) for the Mac OS® operating system. In some implementations, the dashboard clients 302 can be implemented as simplified browser screens that omit conventional interface features such as a menu bar, window frame, and the like.

### Widget Format

In one implementation, each widget 303 is implemented as an HTML file. The HTML file can reference other local and remote resources such as style sheets (e.g., Cascading Style Sheets), other HTML files, JavaScript files, images, and the like. Widgets 303 can be implemented using, for example, a flat bundle file format or a packaged HTML file format. In some implementations, the Flat Bundle format includes an info.plist file.

The Info.plist file describes a widget 303 and provides an identifier for a widget 303. Table I provides an example of an Info.plist file contents.

TABLE I
Example of Info.plist File Contents

| Key | Type | Description/Value |
|---|---|---|
| CFBundleIdentifier | CFString | com.apple.widget <widget name> |
| CFBundleName | CFString | Name of the widget. |
| MainHTML | CFString | Name of main HTML resource. |
| Width | CFNumber | Default width of the widget. |
| Height | CFNumber | Default height of the widget. |
| DefaultImage | CFString | Resource name of default PNG file. |
| Plugin (optional) | CFString | Resource name of native plug-in. |
| AllowFileAccessOutsideofWidget | Boolean | Access to files across the file system; |
| | | limited by the users permissions. |
| AllowFullAccess | Boolean | Access to the file system, Web Kit and |
| | | standard browser plug-ins, Java applets, |
| | | network resources, and command-line utilities. |
| AllowInternetPlugins | Boolean | Access to Web Kit and standard browser plug-ins. |
| AllowJava | Boolean | Access to Java applets. |
| AllowNetworkAccess | Boolean | Access to any resources that are not file based. |
| AllowSystem | Boolean | Access to command-line utilities using widget |
| | | script object. |

The keys AllowFileAccessOutsideofWidget, AllowFullAccess AllowInternetPlugins, AllowJava, AllowNetworkAccess, and AllowSystem are Boolean types that can be set by a widget author to enable certain levels of resource access.

### Dashboard Invocation

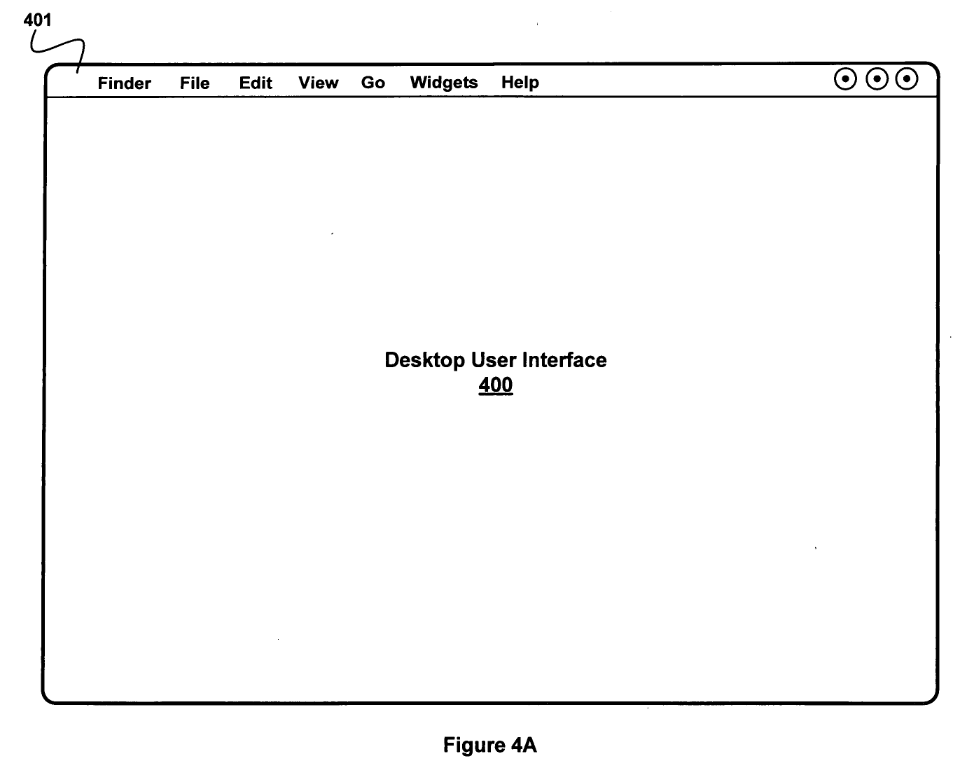

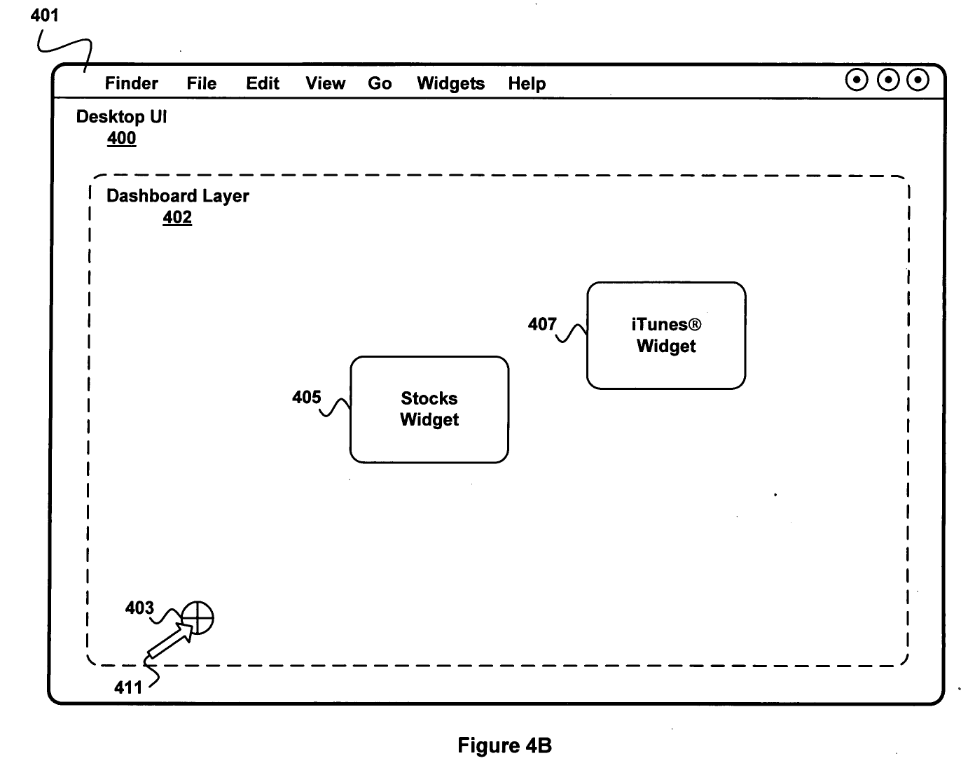

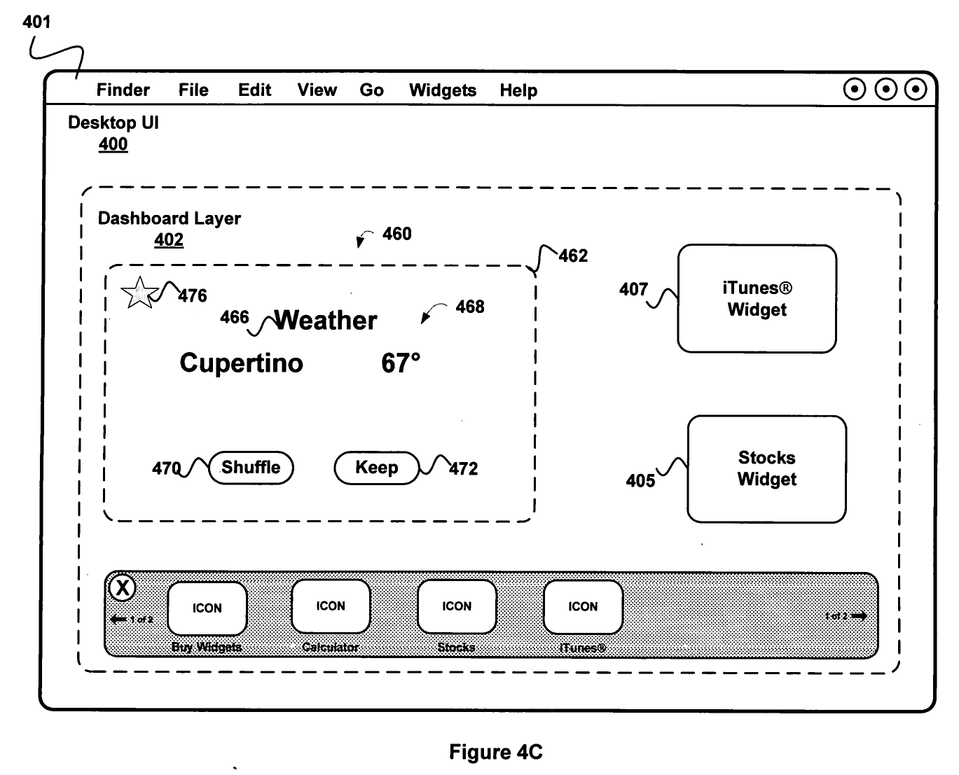

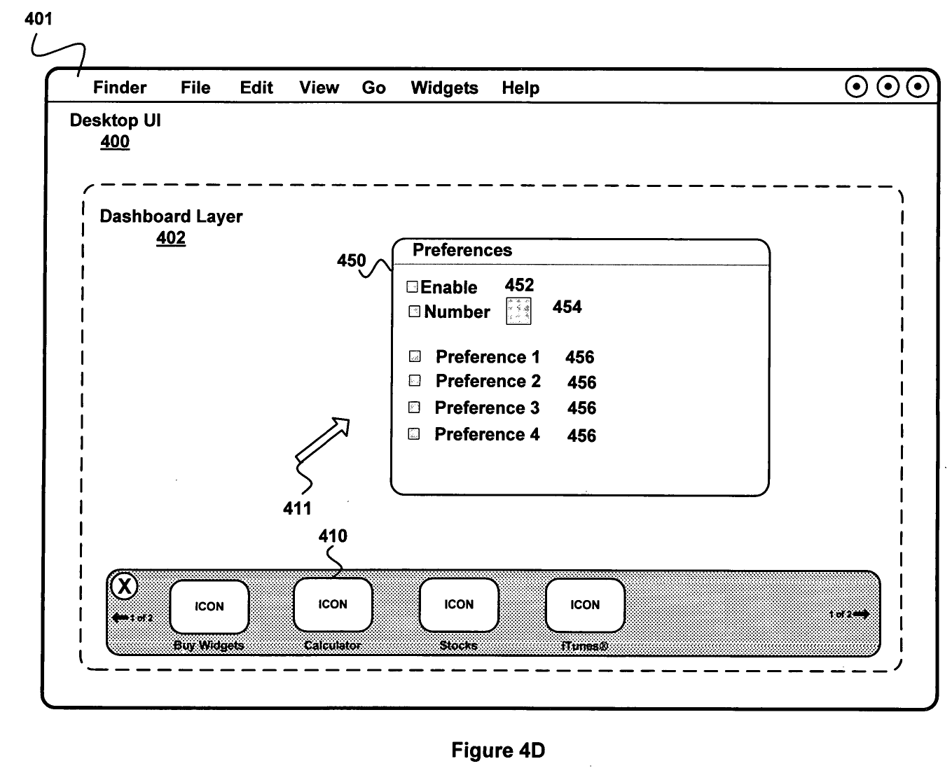

FIG. 4a depicts a desktop user interface 400 prior to activation of a dashboard. The desktop user interface 400 (also referred to herein as “desktop”) is a conventional user interface as may be provided by an operating system, such as Mac OS®. The desktop 400 has a background image, menu bar 401, and other standard features. As is known in the art, the desktop 400 may also include windows, icons, pointers 411 and other elements (not shown). The user, as described above, can activate the dashboard by selecting an item from a menu, or by clicking on an icon, or by pressing a function key or key combination, or by some other means for invoking activation.

FIG. 4b depicts an initial state for a dashboard. In some implementations, a configuration icon 403 is initially displayed. Alternatively, upon activation the dashboard can display one or more default widgets. If the dashboard has previously been activated and configured, the widgets can be displayed as previously configured. As shown in FIG. 4b, the dashboard itself is not necessarily visible as a distinct layer. However, its various components (such as widgets 405, 407, icons, and other features) are visible. In some implementations, these components are displayed in a transparent layer, thus maintaining the visibility of the desktop 400 to the user. In some implementations, the desktop 400 and its components are darkened (or blurred, or otherwise visually modified) while the dashboard is active, so as to emphasize that the desktop 400 is temporarily inactive. In other implementations, the desktop 400 is not visible while the dashboard is active. The user can reactivate the desktop 400 and dismiss the dashboard by clicking on an area of the screen where no dashboard element is displayed (i.e., “negative space”). In some implementations, other commands, key combinations, icons, or other user input can be used to dismiss the dashboard.

### Installation of Elements

Elements, including user interface elements such as widgets can be installed/instantiated in a display environment as discussed below. One display environment, a dashboard, will be used for illustrative purposes. Installation/instantiation can include selection of the element manually, such as by a drag and drop action, or automatically. Manual installation and installer processes are described in greater detail in “Preview Including Theme Based Installation of User Interface Elements in a Display Environment.” Other selection means can be used.

In one particular implementation, selection of one or more user interface elements can be performed automatically based on population parameters (e.g., allowing for the presentation of un-specified widgets in a dashboard). The population parameters can include a default set of parameters that define a default state for the automatic population process. In one implementation, the default state for population is “no automatic population”. Other default states are possible, including those that will determine a number, kind, location and manner for installing the user interface elements. The automatic population of user interface elements can be performed by a selection engine process, or other equivalent means.

### Selection Engine Process

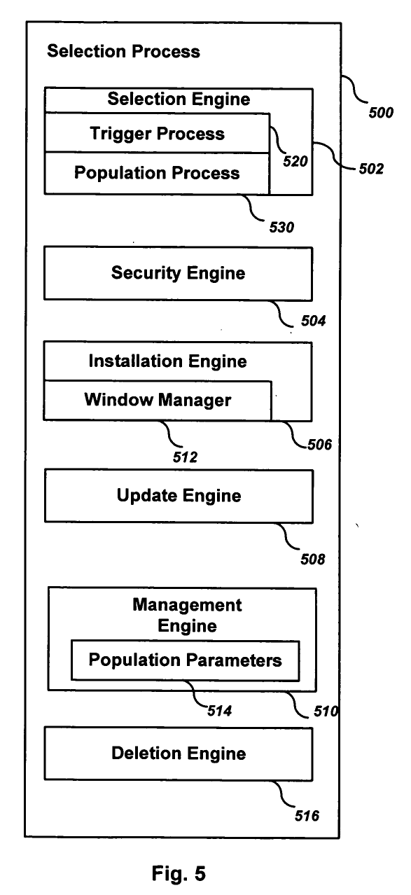

FIG. 5 is a block diagram of a selection tool 500 for automatically selecting user interface elements (e.g., widgets) to be displayed in a display environment, including a selection engine 502, a security engine 504, an installation engine 506, an update engine 508 and a management engine 510. Reference will be made in the following text to the automatic population of widgets in a dashboard. Those of ordinary skill in the art will recognize that the automatic population processes and structures are equally applicable to other user interface elements and other display environments (e.g., desktop, device, etc.).

### Selection Engine

The selection engine 502 is used to select one or more widgets for population of the display environment. Selection engine 502 includes a trigger operation 520 for determining when selection needs to occur, and a population operation 530. Associated with the population operation 530 are population parameters 514. As will be discussed in greater detail below, the population parameters 514 can be maintained and updated in accordance with the management engine 510.

The trigger operation 520 determines when the automatic selection of widgets should be initiated. The trigger operation 520 can evaluate trigger conditions that are specified and maintained by the management engine 510. The trigger operation 520 can operate in the background and either directly detect or otherwise determine the existence of trigger conditions. Examples of trigger conditions can include the invocation of a dashboard, the invocation of an application or process that is related or linked to a dashboard (e.g., a dashboard can be displayed as a palette of tools for use in an application environment, and accordingly, the invocation of the application environment can cause the automatic invocation of a dashboard that is triggered by the trigger operation 520), an event, a time, a state of an application or a process, a button, an automatic trigger, etc.

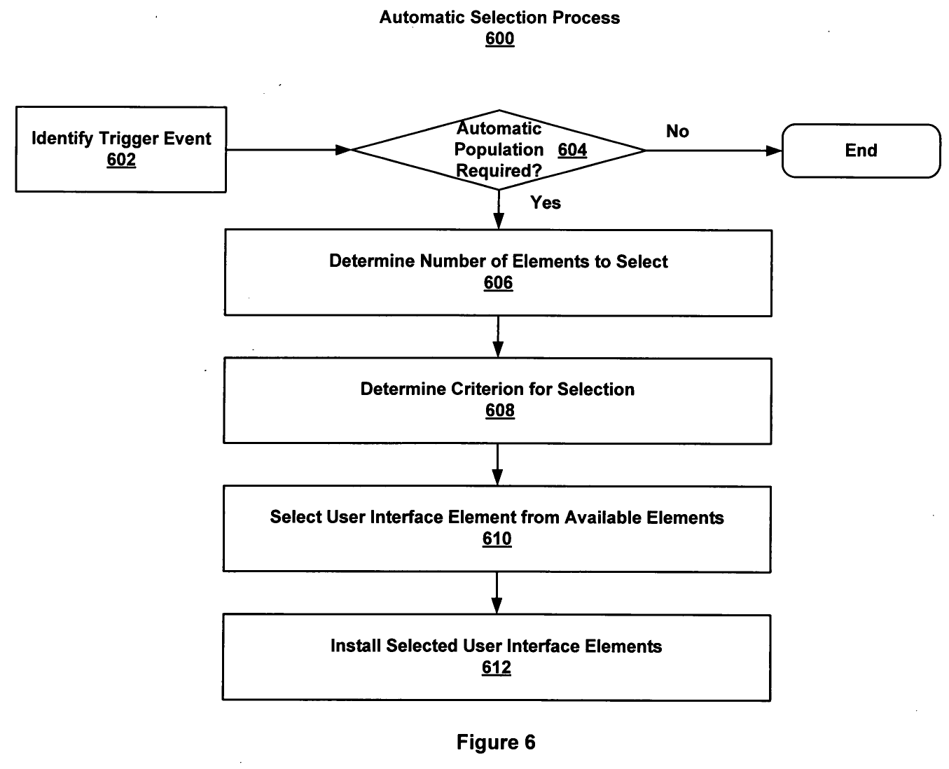

The population operation 530 determines a number of widgets to display in a dashboard, which widgets, along with details of how to display them. The population operation 530 can rely on population parameters 514 to assist in the selection process details. In one implementation, the population operation 530 initially determines a number of widgets that are to be selected automatically. The number of widgets can be selected based on a default or specified value in the population parameters 514. Thereafter, the population operation 530 determines which particular widgets of the available widgets are to be displayed. The population operation 530 can use user input, contextual information, file type information, default data, preferences, cookies, ratings, recent event information (e.g., recently received items) and/or other information to determine which widgets to select. The details of the population operation are described in greater detail below in association with FIG. 6. Finally, the population operation 530 determines how the selected widgets will be displayed in the dashboard. The determination of how the selected widgets are to be displayed can include the determination of a location (e.g., a designated area for display) to display the selected widgets in relation to other selected, default or defined widgets or groups of widgets in the display environment, details of which are described below.

### Security Engine

The security engine 504 is used to determine a security access level (or risk level, or both) for either the user or an element to be installed. Security engine 504 can be used to limit the ability of the user to install particular kinds of elements (e.g., based on categories or criteria) or limit the ability of the selection operation to select particular kinds of elements. In addition or alternatively, security engine 504 is used to determine a security access level (or risk level or both) of an element to be installed. Based on the security access/risk level, one or more operational or functional constraints can be placed on the element. For example, limitations on the ability of the element to interact, access, read or write data, monitor output of other system resources, access other system resources, or other limitations can be invoked. In one implementation, automatically selected widgets are constrained (e.g., resource constrained or otherwise) at initial installation/instantiation so as to ensure the security of the system. The limitations can be temporary, for a predetermined time period, or until the user or system has specifically authorized installation. Functionality or operational capabilities of the element can be enabled or disabled, depending on the access level. The security engine 504 can use metadata associated with the element to be installed/instantiated, user input, contextual information, file type information, default data, read/write preferences, cookies and/or other information to determine the access/risk level. Access control lists including white lists (e.g., including lists identifying certified or otherwise safe elements), black lists (e.g., including lists identifying un-certified or otherwise un-safe elements) and the like can be used to determine the access/risk level. In one or more implementations, the user can be prompted to make a security decision re each proposed element to be installed/instantiated.

In some implementations, widgets are rated according to their content (e.g., adult content, violence, strong language, etc.). The rating can be determined by the author or a third party rating organization. The rating can be used to determine whether a widget will be installed. In some implementations, users can specify which widgets can be installed and/or selected based on ratings. For example, a parent may specify via a preference pane or other input mechanism that widgets containing adult content ratings will not be installed nor selected (i.e., parental controls).

Various techniques for widget security are described in “Widget Security.”

### Installation Engine

The installation engine 506 is used to install or instantiate (e.g., dynamically) a selected element (e.g., a widget selected by the selection engine 502). The installation engine 506, can invoke an installer process for installing/instantiating selected widgets. Installer processes are described in greater detail in “Preview Including Theme Based Installation of User Interface Elements in a Display Environment.” The installation/instantiation can be fully functional or limitations on the functionality, interactions and the like can be set by the security engine 504 as discussed above. Interactivity can include the separate refreshing of content in the presentation window. Alternatively, the content can be static, and only present ornamental properties.

The installation engine 506 determines how and where to install or instantiate the selected widgets in the display environment. Population parameters 514 can be used to set details of the installation/instantiation (e.g., install all in a same location of the display environment, highlight their display, etc.)

In one implementation, a selection designator is associated with an automatically selected widget. In one implementation, the selection designator can be displayed along with the user interface element being installed/instantiated (e.g., widget). The selection designator can be of the form of a frame, a carpet on which a presentation window associated with the widget is disposed, a theme element, or other designator that overlays, surrounds, bounds or otherwise is associated with the presentation window associated with the selected element. The selection designator can be a separate process and embedded within an underlying installer window or the presentation window that, in one implementation, may be a separate process. The selection designator is provided to indicate to a user that the element has been automatically (e.g., dynamically) populated and, as of yet, may not been fully installed/instantiated in the display environment. Further emphasis can be used to convey this information including by using highlights, emphasis, de-emphasis, effects, transitions and the like. The combination of the presentation window and the selection designator comprise an installation area for the user interface element to be installed/instantiated. The installation area can be part of the display environment in to which the element is to be installed/instantiated (e.g., part of the dashboard) or part of a separate display environment (e.g., part of another user interface, another user interface element, another application, or process, etc.).

When displaying an interactive widget in the presentation window, user input can be accepted that can result in changes in the presentation. For example, if the widget includes a URL that may be linked to, interaction can include the generation of an underlying page request and the presentation of the requested page in the presentation window. Interaction with user interface elements is described in “Presenting Clips of Content.” If the interaction is not allowed, a display prompt can be shown to indicate that the operation or function is temporarily disabled during a preview phase (e.g., until the selection has been accepted). Acceptance of selections is discussed in greater detail below in association with update engine 508.

In some implementations, a window manager 512 is associated with the installation engine. The window manager 512 can be a separate process that is used to support the interaction between the presentation window, selection designator and the installation window described above. Window managers are described in “Preview Including Theme Based Installation of User Interface Elements in a Display Environment.”

The installation engine 506 is operative to install/instantiate the selected widget in the display environment. The installation engine 506 can copy or move as required the selected widget to an appropriate volume and store the data structures (including preference data, identification data, scripts, navigation data and the like) for use in the display environment. In some implementations, the installation engine 506 includes an automatic invocation of the underlying display environment with the installed user interface element presented (i.e., the installation engine 506 installs the widget in, and opens up, a dashboard including the installed widget).

### Update Engine

The update engine 508 provides control for selected widgets after installation/instantiation. The update engine 508 can be a separate process from the installation engine 506, or included therein. The update engine 508 can receive input and display user interface elements (dialogs and the like) to ensure that update operations are effectuated as required. The update engine 508 can be responsive to the selection of a user interface element, a portion of the element, controls associated with the element and the like.

In some implementations, the update engine 508 receives mouse over input and displays a graphical element associated with a given identified element. The graphical element can include a control that allows for the activation of a deletion engine (not shown), a tool for making the selected element permanent (e.g., no longer subject to the dynamic selection process and hence permanently part of the display environment), or a tool for re-invoking the selection process (e.g., re-shuffling) or changing parameters associated therewith. The activation can cause the display of a window (e.g., a confirmation window, or management window as discussed below) to ensure appropriate behavior. Other methods for updating user interface elements are possible.

Deletion can include deactivating a user interface element and leaving its associated files on the host system or device, or deleting the user interface element and removing all its associated files from the host system or device. The user can be prompted to confirm deletion of a user interface element before deletion is initiated. Further, deletion of a user interface element can prompt the automatic selection of a replacement element for display in the display environment in accordance with a re-shuffle process. A separate deletion engine 516 can be included in the architecture, as is shown in the exemplary figure.

### Management Engine

Optionally, a management engine 510 can be included that operates to manage the population parameters associated with the automatic selection operations described herein. The management engine 510 can include a user interface that includes one or more user interface elements for managing the parameters. Management can include setting values associated with the number of user interface elements to select. Other settings can include whether to use the automatic selection operation (e.g., enable/disable automatic selection), preferences for selection criteria including personal preferences, group preferences, context preferences, ratings, behavior, and use preferences and the like. Other selectable parameters can include designator selections (e.g., selection of designator to include if any with a “automatically populated” selection), location preference, and display preferences (highlighted, emphasized, de-emphasized, etc.). Other population parameters are possible.

An example of a management window is shown in FIG. 4d. Management window 450 includes enable button 452 (for enabling and disabling automatic population), number selection scroll 454 (for allowing for the designation of a specified number of user interface elements to be added to the display environment), and other population parameters 456 (e.g., re-shuffle enable, re-shuffle parameters, favorites, etc.) that may be selected by checkbox or pull-down menus. Other management windows are possible, and the particular implementation shown is merely exemplary.

### Dashboard Environment

In a dashboard environment, selection operation 500 can be of the form of a separate or integrated operation that, upon triggering of the display of an automatically configured dashboard, will be invoked to automatically populate a dashboard. The automatic population includes the selection of available widgets for installation/instantiation from a widget bar or other location depending on the configuration of the selection operation. The number of user interface elements to be selected can be specified (e.g., explicitly, automatically, implicitly or otherwise), resulting in the population of a portion or the entire dashboard.

### Desktop Environment

In a desktop environment, selection operation 500 can be of the form of an installer application that can be invoked (e.g., automatically, by the user, by the operating system, by an application or other invocation tool) to present user interface elements in the desktop environment. The installer application can include population parameters and an associated installer/instantiation process. The installer process when invoked can cause the automatic selection of user interface elements and subsequent display of the selected user interface elements in the user interface. The installer process can also be invoked to manage properties of the automatic installation as appropriate.

### Device Environment

In a device environment, selection operation 500 can be of the form of a device application that can be invoked (e.g., automatically, by the user, by the operating system, by an application or other invocation tool) to present user interface elements on a display of a device. The installer application can include population parameters and an associated installer/instantiation process. The installer process when invoked can cause the automatic selection of user interface elements and subsequent display of the selected user interface elements in the user interface of the device. The installer process can also be invoked to manage properties of the automatic installation as appropriate.

### Selection Process

FIG. 6 is a flow diagram of an operation for automatically installing a user interface element (e.g., a widget) in a display environment. The operation includes identifying a trigger event (602). The trigger event can be the invocation of a display environment (e.g., opening of a dashboard), an application event (e.g., a search operation is invoked and a search dashboard is automatically invoked including population with search widgets), or any other type of trigger. Thereafter, a check is made to determine if an automatic selection process is required (604). The enablement or disablement of the automatic selection operation can be specified in population parameters maintained by the system. The check can include a check to determine if space is available in the user interface for display of otherwise unspecified user interface elements in addition to other explicitly or default designated user interface elements.

If no automatic population is required, the operation ends (e.g., the system operates conventionally, including potentially displaying a dashboard or other display element having all pre-defined user interface elements).

If automatic population is required, then a number of elements to select is determined (606). The number of elements to select can be specified in population parameters. Alternatively, the number of elements can be determined by evaluating the available space in the display environment. Alternatively, the user or the system can define an area for display of automatically populated elements, and accordingly, the determination of the number can be based on the size of the available display area. In another implementation, the user can be prompted to determine if he/she wants to populate a portion of the display environment automatically. The prompt can be made by a management engine (e.g., management engine 510).

After the number of elements is determined, one or more criterion for selection is determined (608). The criterion can be defined (e.g., including pre-defined default criterion) or inferred, explicitly, implicitly or otherwise specified. The criterion can include preferences. The preferences can include the specification of preferred sources or content. For example, preferences can be selected or set to define one or more selected widgets be from a list, a favorites list, others favorites, or be based on popularity, use, cost, accessibility, capabilities, age, ratings or otherwise. For example, a user can specify that when a dashboard is invoked, one or more widgets should be automatically selected that are the most recent widgets available on a given site or from a certain distributor. Alternatively, preferences can be specified that the most actively downloaded widgets from a given site be selected. Many other preference options are possible. In another example, the selection of unspecified elements to be displayed can be based on location information (e.g., the location of where the dashboard is launched from (e.g., from a specific application)). Different display elements can be selected based on the current location (e.g., of the cursor, of the user experience, of the user application, etc.). In one implementation a widget can be displayed that helps in determining the criterion.

After the criterion is determined, selection from available elements to satisfy the number and criterion is made (610). The selection can include the identification of candidate elements, testing of the candidate elements against criterion (e.g., population parameters including ratings and security considerations), and ultimately acceptance or rejection of a given candidate. Preferences in the population parameters can determine which elements are evaluated before others. Alternatively, all available elements can be evaluated, and ones best satisfying the population parameters can be selected. Identifying candidate user interface elements can include locating available widgets. Locating can include using a search tool or the like to locate widgets available for installation. Locating and selecting can include selecting a user interface element from a configuration bar, a widget bar, a tool bar, a menu, an authoring application, a local or remote source or other source. In one implementation, selection can be made with the assistance of a selection widget.

After identification, the identified user interface element is installed/instantiated (612). Installation/instantiation can include determining display preferences for the selected items (e.g., determining if any selection designators are required, determining a location to install the selected item, determining any restrictions on installation, etc.), and downloading the user interface element from a content source or other source. Installation/instantiation can include launching an associated installation process for installing the user interface element, and optionally a preview application for previewing the user interface element prior to installation or other application including authoring applications. The launching of the applications can be automatic or user or otherwise selectively controlled.

The installer process presents an installation/instantiation window including the selected item. An example of an automatically selected widget in a dashboard environment is shown in FIG. 4c including an installation window 460. In some implementations, the installation window 460 includes a user interface display portion 462, and can include a prompt, and or one or more interactivity elements. The user interface display portion can include a reference 466 and a static or dynamic element 468. The reference can be a complete or partial reference, a pointer, a designator, a still image, or otherwise that identifies the user interface element.

The prompt can be of the form of a confirmation to the user of the underlying action (e.g., this widget was automatically selected based on your criterion, do you want to install it?). In one implementation the prompt can be used to confirm a desire to install (e.g., permanently) a named widget. Alternatively, no prompt and automatic and complete installation/instantiation of the user interface elements (e.g., widgets) is provided. In other implementations, the prompt can be used to confirm not only the named user interface element for installation/instantiation, but the display environment into which the user interface element will be installed (e.g., “Install named widget #1 on my desktop?” or “Install widget #1 on dashboard #1 of 2?”). In still other implementations, the prompt can include a confirmation of an action (e.g., “install the widget and open it in my dashboard”).

The interactivity elements can be of the form of buttons or the like. In the implementation shown, the installation/instantiation window can include three interactivity elements including a shuffle element 470 (e.g., a shuffle button), and an installation element 472 (e.g., a keep button). Other interactivity elements are possible, including those that link to other associated applications, content sources (e.g., to allow for the selection of a different widget for installation) and the like. The shuffle button can be used to deselect the current selection, re-invoke the selection process and load a new selection in accordance with the conventional selection process. Re-shuffle operations are described in greater detail below.

Other buttons or user interactivity features can be included with the user interface element. For example, a third button for invoking the management engine to allow the user to change population parameters can be provided along with the user interface element.

In some implementations, theme content can be presented along with the user interface element such as an automatic selection designator 476. As discussed above, the automatic selection designator 476 can be used to indicate that the user interface element was automatically, rather than otherwise specified.

Associated with the installation/instantiation process may be an authoring or re-selection or update operation. For example, if the element displayed is not satisfactory to a user (e.g., the theme content is unsatisfactory), or if the environment changes, an update operation can be invoked (e.g., using the re-shuffle button). The update operation can be invoked by the user or automatically. Update operations are described in greater detail below. Finally, the user interface element can be installed/instantiated. The installation/instantiation of the user interface element can include the installation on a tool bar (e.g., a widget bar), in a resource, in a widget manager in addition to a given display environment (e.g., directly on a dashboard or the desktop). Installation/instantiation can include the saving of the underlying content metadata including data structures defining the user interface element in a library or the like. Alternatively, the installation/instantiation can be part of an underlying application (e.g., directly in an associated dashboard application or a library associated therewith).

The operation steps described can be performed in other orders, repeated or the like to provide desired results. For example, the selection operation can be repeated in association with the selection of multiple different user interface elements prior to invoking the installation/instantiation step.

Once installed/instantiated, user interface elements can be removed/deleted/updated from the display environment as required. In some implementations, a separate deletion operation is provided from the installation operation. Alternatively, an installer process or a management process can be invoked to remove/delete/update user interface elements as required.

### Widget Manager

In some implementations, a widget manager allows users to inspect, remove, enable and disable widgets. The widget manager can be a preference pane, a standalone application or a plug-in. The widget manager displays widget information, including but not limited to the widget's title, author, version, class, type, ratings, description, etc. The information can be displayed in any order and format according to one or more sorting criteria, such as alphabetical or chronological order, author, class, rating, etc. In some implementations, the widget manager tracks widget updates and automatically notifies the user or host system or device when an update is available. Widget managers are discussed in more detail in “Management Of User Interface Elements In A Display Environment.”

At different points in time, the display environment may be required to be updated where automatically selected widgets have been presented. Changes to the display environment can require updates to the selection and presentation of user interface elements in the display environment. In some implementations, the updates can be triggered automatically or manually. For example, after presentation of the automatically selected user interface elements, the user may elect to re-shuffle the selection. The re-shuffle may be manually triggered by the user or automatically triggered based on one or more criterion. For example, where automatic re-shuffle is enabled, a re-shuffle can be invoked after a predetermined amount of time (e.g., so as to present a currently more popular widget, or more frequently accessed widget if that is desired), based on use or lack of use (e.g., to shuffle out a widget that has not been used with another that may be of interest to the user), based on change of context (e.g., the user changing which application is in front or otherwise active) or changes of one or more selected criterion (e.g., change to a criterion that was used to originally select the user interface element), or other reasons.

As used herein, the term re-shuffle refers to an operation for re-enabling the selection operation to provide for one or more alternative selections. To ensure that the same user interface elements are not selected, different criterion can be used. Alternatively, the initially selected user interface elements can be marked or otherwise designated as un-available. In one implementation, a re-shuffle will result in a random or semi-random selection from the available user interface elements.

In particular, one skilled in the art will recognize that other architectures and graphics environments may be used, and that the present invention can be implemented using graphics tools and products other than those described above. In particular, a client/server approach is merely one example of an architecture for providing the dashboard functionality of the present invention; one skilled in the art will recognize that other, non-client/server approaches can also be used.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the processes herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms, modules and processes presented herein are not inherently related to any particular computer or other apparatus. Various general-purpose systems may be used with programs in accordance with the teachings herein, or it may prove convenient to construct more specialized apparatuses to perform the method or process steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the processes, modules, engines, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A method comprising
determining for a display environment when a number of unspecified user interface elements are desired to be displayed;
automatically selecting user interface elements from available user interface elements to satisfy the number; and
displaying the selected user interface elements in the display environment.

2. The method of claim 1 where determining a number includes determining available space for presentation of unspecified user interface elements.

3. The method of claim 1 where determining a number includes receiving user input defining a number of unspecified user interface elements to automatically populate in the display environment.

4. The method of claim 1 where determining a number includes determining a number of user interface elements that can be displayed in the display environment such that all user interface elements that are to be displayed are automatically selected rather than explicitly defined.

5. The method of claim 1 where automatically selecting includes identifying one or more criterion for making a selection, and selecting in accordance with the criterion.

6. The method of claim 1 where automatically selecting includes determining user preferences for selection, and using the user preferences in selecting the user interface elements for display.

7. The method of claim 1 where automatically selecting includes determining a current context, and selecting user interface elements in accordance with the context.

8. The method of claim 1 where displaying includes displaying the selected user interface elements in a predetermined portion of the display environment.

9. The method of claim 1 where displaying includes displaying a designator along with the user interface element to indicate the selection was automatically made.

10. The method of claim 1 further comprising
determining if an update to the display environment is required, and if so, then updating display including repeating one or more of the determining, selecting and displaying steps.

11. A method for populating a dashboard comprising:
determining a number of unspecified widgets that are desired to populate a dashboard;
determining one or more criterion for selecting from available widgets;
selecting from the available widgets in accordance with the criterion; and
displaying the selected widgets in the dashboard.

12. The method of claim 11 where one criterion is based on use of the user interface element by the user.

13. The method of claim 11 where one criterion is based on use of the user interface element by others.

14. The method of claim 11 where one criterion is based on popularity of the user interface element.

15. The method of claim 11 where determining a number of unspecified widgets includes determining a total number of widgets to be displayed on the dashboard along with the number of explicitly or default defined widgets.

16. The method of claim 11 where displaying includes displaying the widgets in a predetermined portion of the display environment.

17. The method of claim 11 where displaying includes constraining the operation of selected widgets.

18. The method of claim 17 where constraining includes constraining the selected widget in accordance with a security risk assessment.

19. The method of claim 11 where the criterion is based on contextual information related to the operation or state of and end device on which the display environment is presented.

20. The method of claim 11 where displaying includes re-shuffling including automatically selecting new widgets from available widgets if a condition is satisfied.

21. A user interface method comprising:
determining a number of unspecified user interface elements to be displayed in a user interface, an user interface unspecified element being one not explicitly specified by either a user or a system prior to generation of the user interface;
selecting user interface elements from available user interface elements based on one or more criterion to satisfy the number; and
displaying the selected user interface elements along with any other explicitly specified user interface elements in the user interface.

22. A method comprising
determining when a number of unspecified user interface elements are desired to be displayed in a display environment; and
automatically populating the display environment with selected user interface elements from available user interface elements in accordance with population parameters.

23. A method comprising:
identifying a user interface for display in a display environment; and
automatically populating the user interface with selected user interface elements in accordance with population parameters including
determining a number of user interface elements that need to be specified; and
selecting the specified number of user interface elements from available user interface elements.

24. A method comprising:
determining if a display environment requires additional user interface elements beyond those specified by a user, an operating system or an active application;
if so, selecting a number of user interface elements from available user interface elements in accordance with one or more criterion; and
displaying the selected user interface elements in the display environment along with any other explicitly specified user interface elements.
